(19) United States
(12) Patent Application Publication
(10) Pub. No.: US 2006/0167691 A1
(43) Pub. Date: Jul. 27, 2006

(54) Barely audible whisper transforming and transmitting electronic device

(76) Inventor: Raja Singh Tuli, Montreal (CA)

Correspondence Address: RAJA SINGH TULI, SUITE 1130, 555 RENE LEVESQUE WEST, MONTREAL, H2Z 1B1, CA

(21) Appl. No.: 11/041,733

(22) Filed: Jan. 25, 2005

(51) Int. Cl. G10L 13/00

(52) U.S. Cl. 704/258

(57) ABSTRACT

The present inventions aims to transform, and later amplify, a barely audible whisper of a speaker's voice, received in a microphone within an electronic device capable of transforming and transmitting voice, in terms of its speech characteristics into a synthetic voice that closely mimics a non-whisper voice of the speaker. The device, equipped with a computer that processes sound, learns to transforms voice in a learning mode and can operate with a range of ultra low volumes. Microphones in the device can be directional to localize areas of sound source. The computer also equalizes the sound for distance between the speaker and microphone. It can further identify and adjust volume on hard stops and shrill sounds that become pronounced especially in a barely audible whisper.

### BACKGROUND OF THE INVENTION

The present invention relates to a field that transforms and synthesizes a very softly spoken speech that is barely audible into a normal audible sound in an electronic device capable of transmitting voice to another person such as a telephone, cellular phone etc. Examples of prior art that enhance a normal whisper to regular speech are U.S. Pat. No. 6,363,343 and U.S. Pat. No. 5,852,769. Whisper detecting phone ideas are not new. U.S. Pat. No. 1,376,719 by Molloy was a very early attempt. The prior art mentioned above do not mention or suggest a transformation and synthesizing of speaker's voice in terms of pitch, energy, duration or other speech characteristics and instead focus on a simple volume gain or a temporary boost of gain in speech signal strength. Such a transformation in terms of speech characteristics, as documented by Baruch in U.S. patent application 20040054524 is not available for telephone or cellular phones. The speech transformation presented by Baruch is one in which speaker's voice is digitally converted into a voice of another person only based upon speech characteristics. However, use or application of the transformation with a voice-transmitting device is not envisaged. The present invention aims to effect a digital transformation and synthesis of a speaker's voice which is a barely audible whisper or an extremely faint whisper into a normal voice which resembles very closely to the speaker's own voice.

### BRIEF SUMMARY OF THE INVENTION

The present invention relates to the concept of digitally transforming and synthesizing a speaker's own voice in terms of speech characteristics from a barely audible whisper tone (not just a normal low whisper tone) in an electronic device capable of transmitting voice to another person such as a wired or cellular telephone. The concept is also applicable to a wired or wireless headset connected to the electronic device. Once in a selectable whisper mode, the speaker talks in an ultra low tone that is barely audible. This, ultra low voice tone, is sensed by microphones located in the electronic device. The microphones can be directional microphones such as phased-array microphones, located in an electronic device. The sound picked up by the microphones is digitized and then transformed and synthesized, by a computer, into a non-whisper sound by changing at least the pitch and additionally energy, duration and other speech characteristics of the original sound. This newly synthesized sound is very closely similar to a normal non-whisper speech sound of the speaker and as such very closely mimics the voice of the speaker. The newly transformed and synthesized sound is then amplified and sent to a receiver at another end of the electronic device as well as to the speaker itself for verification. The amplification can be varied if the speaker chooses to change it.

The computer on the electronic device can also operate in a learning mode where the computer learns transformation of speech characteristics as the speaker changes voice tone from a barely audible whisper to a regular voice speech. Additionally, the computer in the electronic device can operate in a range of voices from barely audible whisper to a normal low tone voice.

The microphones, while sensing the ultra low tone also equalize the sounds due to a distance between the speaker and the microphone. As part of digital transformation and synthesis of the speaker's voice, the computer also identifies and adjusts volume on alphabets within words that are hard sounding such as “d” or “t” or that are shrill sounding such as “s”. Volume is adjusted similarly on low sounding alphabets or words having “h” or some vowels.

### BRIEF DESCRIPTION OF THE DRAWINGS

FIG. 1 illustrates a flow diagram of different stages of an ultra low whispered speech transformation and transmission in an electronic device.

FIG. 2 illustrates a flow diagram of different stages of sound transformation and transmission, including equalization of speech sound, in an electronic device.

FIG. 3 illustrates a flow diagram of different stages of sound transformation and transmission, including smoothing out of hard stops and higher pitches of an ultra low whispered speech sound in an electronic device.

### DETAILED DESCRIPTION OF THE INVENTION

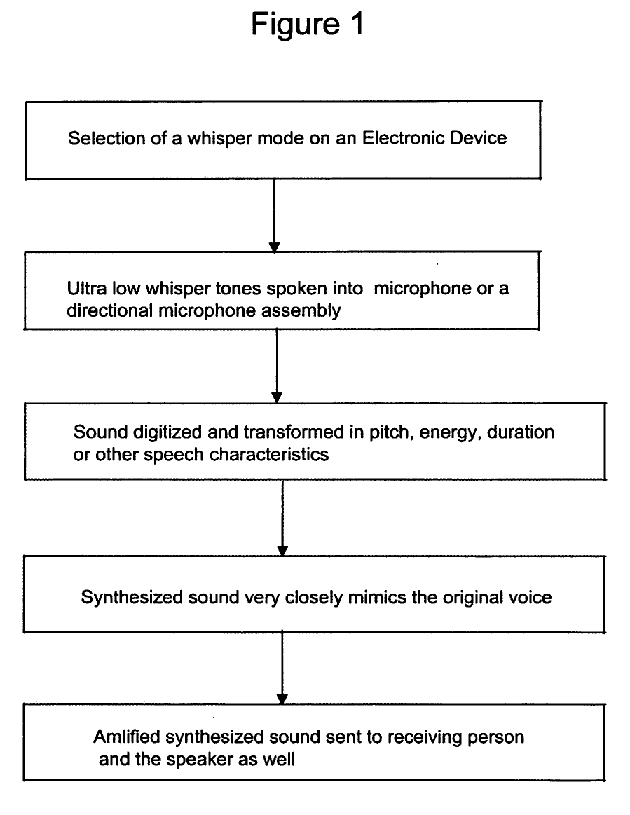

In a principal embodiment of the invention, represented by FIG. 1, a speaker selects a whisper mode on an electronic device capable of transmitting voice to another person such as a telephone or a cellular phone and starts speaking in an ultra low tone or a barely audible whisper. The whisper is such that if another person is standing close to the speaker then that person can only make out movements of the speaker's mouth and is unable to legibly hear any spoken words. This type of speech is effectively breathing phonation. This ultra low tone sets apart the present invention from any prior art wherein a whisper is assumed to be just a low tone voice (for privacy) to be amplified for a receiver. To further elaborate the difference between a barely audible whisper and a whisper typified in the prior art one can classify three types of sounds that can emanate via the human vocal cavity. A human vocal area contains Larynx commonly called a voice box. The Larynx contains folds of muscles commonly called vocal cords. Sounds that are produced with tense vocal cords are known as voiced sounds. If the vocal cords are relaxed then the sound produced is voiceless sound. However, if the vocal cords are only partially closed a typical whispering sound is produced. The aim of this invention is to focus on sounds produced just above the voiceless sounds that are effectively a barely audible whisper. This barely audible whisper is not suitable for a simple amplification of low tone sound as mentioned in the prior art. As such a transformation of speech characteristics is needed where at least a translation in sound pitch is required.

The ultra low tone of the barely audible whisper is sensed by a microphone, preferably directional, in the electronic device and is digitized. The digitized sound is then transformed, by a computer contained in the electronic device, at least in pitch with possible additional transformation in energy, duration, silence and background noise into a voice of a higher pitch and energy that is very similar to the original non-whispering voice of the speaker. The transformation of speech here is contrasted with the typical gain control that is mentioned in the prior art. The transformation and synthesis performed here are completely different from a typical gain control often mentioned in the prior art. The transformation here is actually a transformation of different speech characteristics to synthesize, from a barely audible whisper, a normal audible voice close to the normal non-whisper voice of the speaker. In a typical gain control the signal strength of a voice is simply amplified in the gain control circuit and transmitted to the receiver. There is no transformation of any speech characteristic involved.

The newly transformed and synthesized voice is then amplified and is transmitted to the receiving person. For verification purpose the synthesized voice is also fed back to the speaker to ensure the quality and clarity of the amplified digitized sound. If the speaker wants to change the amplification then it has the option of doing so to have greater quality and clarity of sound. In a related embodiment, a wireless or wired headset connected to the electronic device is capable of performing identical functions.

In a further related embodiment of the present invention, the directional microphones in the electronic device are a phased array microphone assembly. Directional microphones such as the phased array microphones localize the area from which sound waves arrive to be detected. This helps to reduce background noise that can filter in a conversation. Since position of a speaker's mouth can be fairly well approximated, directional microphones can substantially reduce background noise.

In another embodiment of the present invention, the computer contained in the electronic device has a learning mode. In the learning mode the computer senses regular voiced speech and barely audible whisper when phrase or a words is spoken in an ultra low tone and then again spoken in regular voiced speech. The computer learns transformation of speech characteristics taking place in the sound it detects, as the speaker goes from the ultra low tone to a regular voiced speech for the same word or phrase. Progressively, the phrases can become longer as the computer learns to handle range, complexity and randomness of a normal conversation. This allows the computer to learn how to transform a barely audible whisper to a real life voice sound of the speaker.

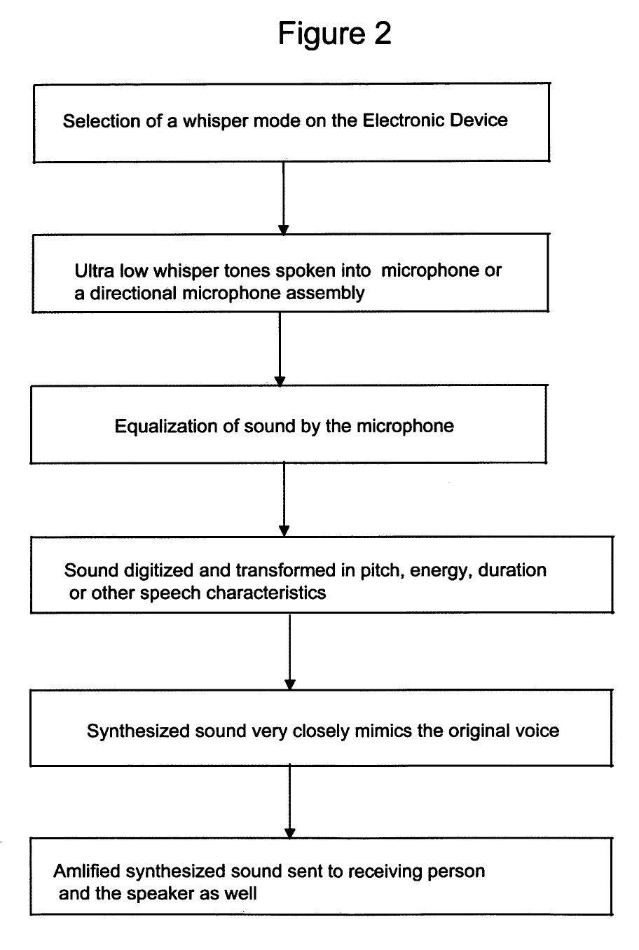

In another embodiment of the invention, represented by FIG. 2, a speaker selects a whisper mode on an electronic device capable of transmitting voice to another person such as a cellular phone and starts speaking in a barely audible whisper. The microphone senses the ultra low tone and the sound are equalized due to compensate for a distance between the microphone and the speaker. This equalization is needed as the distance between the speaker and the telephone may vary continuously within a range. The digitized sound is then transformed at least in pitch and possible additional transformations of energy, duration, silence and background noise into a voice of at least a higher pitch that is very similar to the original voice of the speaker. This newly synthesized speech is then amplified and is transmitted to the receiving person. For verification purpose the synthesized voice is also fed back to the speaker to ensure the quality and clarity of the amplified digitized sound.

In a further embodiment of the present invention as the electronic device is operating in the whisper mode, the computer in the device is capable of transforming received audio signals that have a range from a barely audible whisper up to a normal whispering sound. The microphones in the device sense the signal strength of received audio and transform them accordingly such that the final synthesized speech is uniform. This capability is needed as it is difficult to maintain uniform bare audible whisper tone for long and there are inevitable variations in voice strength.

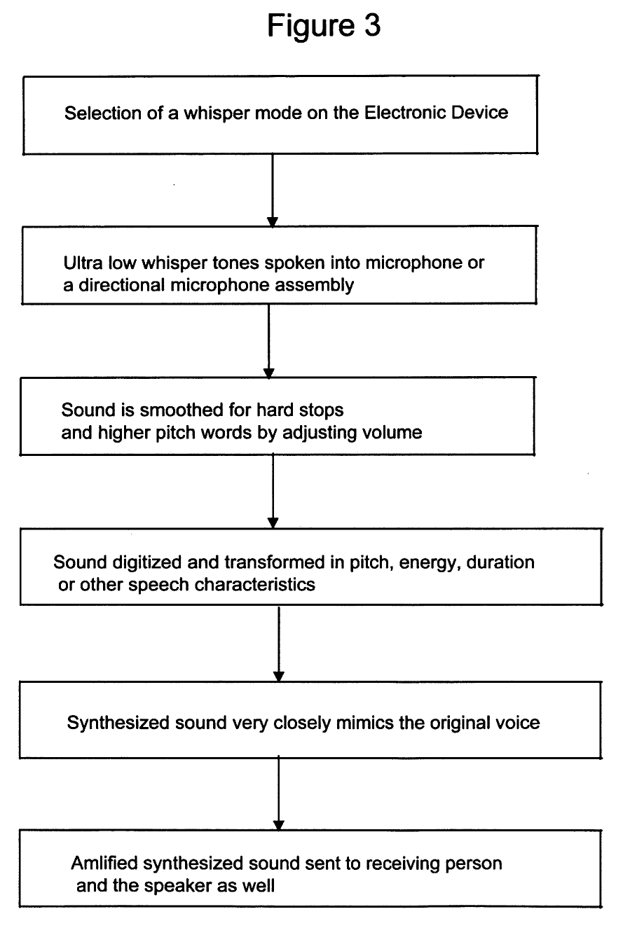

In another embodiment of the invention, represented by FIG. 3, a speaker selects a whisper mode on an electronic device capable of transmitting voice to another person such as a telephone or a cellular phone and starts speaking in an ultra low tone or a barely audible whisper. The microphone senses the ultra low tone and the sound digitized. As an initial part of digitization the spoken analogue message is smoothed out for hard stops or high pitch word or alphabets. For instance, when whispering there is more emphasis on words ending with a “d”, “b” or a “t”. These would be like hard stops that are simply delivered in an amplified manner compared to rest of the speech especially in a whisper. Like the sentence “You did it” when whispered would produce hard stops at “d” and “t”. Similarly the phrase “Shall we . . . ” has a higher pitch in “Sh”. The emphasis on these hard stops and higher pitches is there because the difference of volume between these and average speech is greater in barely audible whisper than within a regularly voiced speech. The computer in the device identifies these hard stops and higher pitches within the ultra low tone and smoothes them out at least to the level as observed in regularly voiced speech, by adjusting the volume at different places in the spoken message, when the device is in a whisper mode. Similarly sounds involving only “h”, and some vowels go down in volume especially in a whisper and have to be compensated for the volume loss in a transformation to a regular voice. The digitized sound is then transformed at least in pitch and possible additional transformations of energy, duration, silence and background noise into a voice of a higher pitch and energy that is very similar to the original voice of the speaker. The newly synthesized voice is then amplified and is transmitted to the receiving person. For verification purpose the synthesized voice is also fed back to the speaker to ensure the quality and clarity of the amplified digitized sound.

What is claimed:

1. A digitally transforming and voice synthesizing electronic device capable of transmitting voice, equipped with a computer, which on a selection is configured to:
receive a barely audible whispering sound of a speaker;
digitize the received sound;
transform speech characteristics of the sound to synthesize a normal non-whisper voice tone very close to that of the speaker;
transmit the synthesized sound to a receiving person.

2. A digitally transforming and voice synthesizing electronic device capable of transmitting voice, equipped with a computer, which on a selection is configured to:
receive a barely audible whispering sound of a speaker;
digitize the received sound;
transform a pitch of the sound to synthesize a normal non-whisper voice tone very close to that of the speaker;
transmit the synthesized sound to a receiving person.

3. A digitally transforming and voice synthesizing electronic device capable of transmitting voice, equipped with a computer, which on a selection is configured to:
receive a barely audible whispering sound of a speaker;
digitize the received sound;
transform the pitch of the sound to synthesize a normal non-whisper voice tone very close to that of the speaker;
amplify the synthesized sound;
transmit the synthesized sound to a receiving person.

4. The electronic device with the computer as in claim 1, such that the transmitted voice is also fed back to the speaker.

5. The electronic device with the computer as in claim 1, such that the computer can operate in a learning mode that comprises of:
sensing barely audible whisper tones of words and phrases that are followed by the same words or phrases in regular voice;
learning transformation of speaker's voice from a barely audible whisper to a regular voiced speech as it detects the transformation of speech characteristics involved when the speaker's voice makes the transition.

6. A digitally transforming and voice synthesizing electronic device capable of transmitting voice, equipped with a computer, which that on a selection is configured to:
receive a barely audible whispering sound of a speaker;
equalize the received sound;
smooth out hard stops such as “d” or “t” and higher pitched words by adjusting the volume;
digitize the received sound;
transform speech characteristics of the sound synthesize a normal non-whisper voice tone very close to that of the speaker;
transmit the synthesized sound to a receiving person.

7. A digitally transforming and voice synthesizing electronic device capable of transmitting voice, equipped with a computer, which that on a selection is configured to:
receive a barely audible whispering sound of a speaker;
equalize the received sound;
smooth out higher pitched words such as words with “sh” by adjusting the volume;
digitize the received sound;
transform speech characteristics of the sound synthesize a normal non-whisper voice tone very close to that of the speaker;
transmit the synthesized sound to a receiving person.
